(19) United States
(12) Patent Application Publication
(10) Pub. No.: US 2009/0248544 A1
(43) Pub. Date: Oct. 1, 2009

(54) REVERSE PRODUCT PURCHASE IN A VIRTUAL ENVIRONMENT

(75) Inventor: Howard Ganz, North York (CA)

Correspondence Address: Pearne & Gordon LLP, 1801 East 9th Street, Suite 1200, Cleveland, OH, 44114-3108, US

(73) Assignee: Ganz, an Ontario partnership consisting of 212100 Ontario Inc. and 2121812 Ontario Inc., Woodbridge (CA)

(21) Appl. No.: 12/061,094

(22) Filed: Apr. 2, 2008

(30) Foreign Application Priority Data
Apr. 1, 2008 (CA) 2623966

(51) Int. Cl. G06Q 30/00

(52) U.S. Cl. 705/27

(57) ABSTRACT

A reverse purchase system allows purchasing an item on a website and receiving a virtual version of that item substantially immediately. Subsequent to receiving that virtual version, the user later receives the real version either in the mail or through redemption of a coupon.

### BACKGROUND

Our co-pending application number 11027647, filed Dec. 30, 2004, which discusses a system of interacting with a virtual representation of a real world product and is incorporated in its entirety herein by reference. According to this system, a user can buy a toy such as 100 which is associated with a special code. The toy 100 exists in the real world, and the code forms a key to the virtual world 110. The user enters the code 105 on a website and enters the virtual world 110.

The virtual world 110 provides activities and views with which the user can interact. The virtual world, as part of the interaction, provides a virtual replica 115 of the actual toy 100. Users can carry out various activities on the website using their virtual version of the toy. For example, the user can form a house with rooms, furniture, things, clothing, and other things. The user can also carry out activities to earn cash, and purchase virtual items using that cash.

### SUMMARY

The present disclosure describes carrying out a first set of actions on a website shop to purchase an item on the website shop. Responsive to purchasing the item, a virtual version of the item that can be used on a website is obtained immediately, and on the website. A real version of the item is received subsequent to receiving said virtual version of the item and responsive to said purchasing said item.

The items can be clothing, a trophy, a media player or other similar items.

### BRIEF DESCRIPTION OF THE DRAWINGS

In the Drawings:

FIG. 1 shows a basic website which allows user interaction with virtual characters; and

FIG. 2 shows a modification that allows both real and virtual characters to be obtained from a purchase.

### DETAILED DESCRIPTION

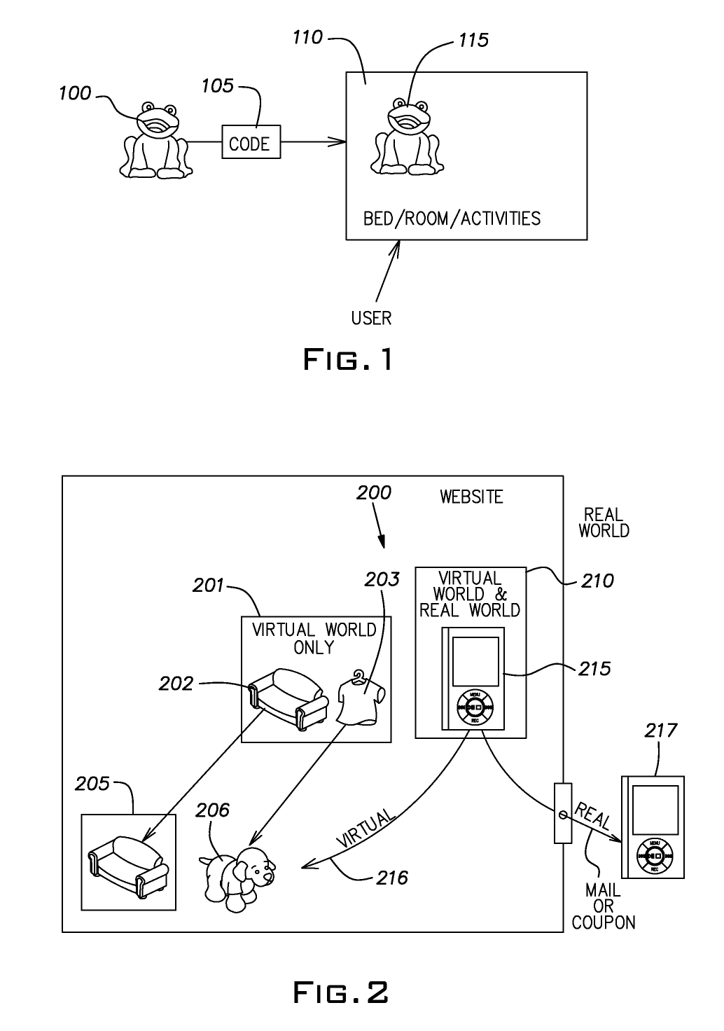

The present application describes additional aspects, actions and activities and additional structure, for adding to a website of the type described in our co-pending application, and as shown generally in FIG. 1. It should be understood, however, that the aspects described herein are not limited to use with the system described in FIG. 1. These aspects can be used with other kinds of websites, for example, any website that allows user interaction can be used with this system. An embodiment describes new operations using the website illustrated in FIG. 1.

In the embodiment, and in websites such as the Webkinz® website, users carry out activities to earn virtual money. The inventor recognized, however, that earning the money is only part of the story—it is also important to find interesting things to do with the money.

For example, on the Webkinz® website, a user can purchase virtual items from virtual shops and those virtual items allow the user to spend the money. In particular, the W shop may have sales, may offer featured items for sale, etc. Therefore according to one aspect, the website's shop interacts between the virtual world and the real world, in that the user in the real world interacts with the shop that is only in the virtual world. For example, the website shop usually only allows the user to buy virtual items, e.g., things that can be used in the virtual world in connection with the virtual characters in that virtual world.

FIG. 2 illustrates an internet-based shop that facilitates interaction between the virtual world and the real world. In this embodiment, the website shop, shown as 200 has a number of items that it can sell. For example, the website shop 200 can have a virtual world only section 201 that can sell items 202, 203 that are usable in the virtual world only. The virtual world only item 202, e.g., furniture, can be purchased and put in the virtual character's virtual room 205. Another virtual world item 203, e.g., virtual clothing, can be used on the user's virtual character 206.

An embodiment of the shop 200 allows selling items that are usable both in the virtual world and in the real world, e.g., housed in area 210. As depicted in FIG. 2, for example, the user purchases one of these virtual items (e.g., an item 215) using either real cash or virtual cash (e.g., that has no value outside the website environment) or some combination thereof. The user receives at least two parts from this purchase: (1) the virtual aspect 216 of the item and (2) the real-world aspect 217 of the item 215. The virtual aspect 216 of the item 215 provides immediate fulfillment of the purchased item, where the virtual aspect 216 includes an item that is usable only on the website and/or some other associated site in a virtual manner. The real, i.e., non virtual part of the item is usable offline or apart from the virtual environment of the website. This part is either sent in the mail to the user as shown in the FIG. 2, or provided via a coupon or certificate that allows the user to bring it into a store or warehouse to pick up the item. But regardless of the manner in which the real-world aspect 217 is acquired, the user can use the real-world aspect 217 outside of the virtual world.

This purchase therefore provides two parts: a virtual part delivered immediately and a real part delivered or fulfilled at some later time. The items virtual aspect 216 and the real-world aspect 217 are preferably recognizable as being the same item, or at least representing the same item. For example, the virtual aspect 216 of the item 215 shown on a website may be a cartoonized version of the real-world aspect 217 of the item.

Different embodiments refer to different items that can be used both in the real world and in the virtual world. For example, one such item may be a media player, such as a portable or handheld media player. This may be a special edition media player, such as a Webkinz™ media player. In the virtual world, the media player is usable to play various types of media and upon purchasing the virtual media player in the virtual world, the user can play media in the virtual world as desired (e.g., immediately after purchase). The virtual version may produce sound that can be heard by the user via the user's computer, or, may only symbolically produce sound so as to create the appearance that the virtual character is being entertained in the virtual world. The virtual version of the media player can optionally resemble the real-world version of the media player that the user will receive in the real world as well. Therefore, the user can see what the real media player will look like before it is received by the user.

In addition, special edition versions of items, such as the Webkinz™ media player, may be available only for certain amounts of time. The real world media player is again either shipped to the user or made available for pick-up at a store using the coupon or an otherwise coded receipt.

The media player, either real, virtual, or both, can store and play various kinds of media. For example, there may be items such as music or videos that can be downloaded from the virtual site to the real world media player. These downloaded items are present on the virtual site and can also optionally be playable on the virtual version of the media player. When played on the virtual version of the media player, the media can be perceived, e.g., seen and/or heard, by users of the website. In addition, those media items may be downloadable from the virtual site into the real world media player when the real world media player is eventually received. The media can be included with the price of the media player, or can be purchased separately using real money or virtual money, or both.

In still another embodiment, another item that can be purchased is clothing, where the clothing in the real world can be for either the user or for the virtual pet. More specifically, virtual clothing can exist on the website. Upon purchase of one or more clothing items, the user immediately obtains the virtual version of the item(s), and then receives the real version that is wearable either by the real toy 100 represented by the virtual character 115 in the virtual world, or by the user in the mail or by coupon or the like.

This embodiment describes purchasing the item on an online store. As such, this is really the reverse of the Webkinz® concept that is described in our co-pending application. According to that system, the user receives the real world item immediately, and receives the virtual world item later after entering his secret code. In this case, the user receives the virtual item immediately, and receives the world real world item later.

Another aspect relates to the user possibly returning the real world item. Returning the real world item could also cause the virtual item to be automatically removed from the user's account. For example, returning the real world item may require that the user request a special code from the website indicating that they are going to return the real-world item. That code or the issuance thereof can cause the virtual item to disappear from the user's virtual environment. The user may be required to provide that code before they can return the real-world item.

In another embodiment, the user may be required to accomplish a task or activity before being offered an option to purchase an item. For example, the user might be required to win a game or a race, after which the user is offered either a virtual item or a real item for purchase. The item offered for purchase may be related to the task or activity, or unrelated. For example, after winning a race, the user might be offered the ability to purchase a real trophy with real money, or to purchase a virtual trophy with virtual money. Alternatively, the user might be given a virtual trophy for free, but offered the ability to purchase a corresponding real trophy.

After the user had made a purchase according to one of these or similar scenarios, the user may also receive a corresponding real or virtual item, respectively, in a manner similar to that discussed above or in the our co-pending applications.

Other items that can be used in both the real and virtual worlds can be purchased in this way.

The general structure and techniques, and more specific embodiments which can be used to effect different ways of carrying out the more general goals are described herein. Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other items can be purchased and received in this way.

Also, the inventor intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

What is claimed is:

1. A method, comprising:
carrying out a first set of actions on a website shop to purchase an item on the website shop;
responsive to said purchasing the item, receiving a virtual version of the item that can be used on a website, said virtual version being received on said website; and
receiving a real version of the item, subsequent to receiving said virtual version of the item and responsive to said purchasing said item.

2. A method as in claim 1, wherein said first set of actions includes actions to pay for the item.

3. A method as in claim 1, wherein said virtual version of the item is an item that is used on the website, but cannot be used outside the website, and said real version of the item is only used outside the website, and wherein said real version of the item and said virtual version of the item have looks that make them recognizable as being the same item.

4. A method as in claim 3, wherein said virtual version of the item is actuated to carry out a function on the website, and said real version of the item is actuated to carry out the same function outside the website.

5. A method as in claim 4, wherein said virtual version of the item is a virtual media player that allows playing media on the website that can be perceived by a user of the website, and said real version of the item is a physical media player.

6. A method as in claim 1, wherein said receiving comprises receiving via delivery.

7. A method as in claim 1, wherein said receiving comprises receiving a coupon that can be redeemed for the real version of the item.

8. A method as in claim 1, further comprising automatically removing the virtual version of the item when a user returns the real version of the item.

9. A method as in claim 8, wherein said automatically removing comprises obtaining a code indicative of the virtual version of the item having been removed, and requiring said code to return said real version of the item.

10. A system of generating a virtual environment, said system comprising:
a website shop that allows purchasing items using a user interface that is associated with said website shop;
said website shop operative to enable purchasing first items that can be used both on the website and in the real world, and responsive to a purchase of said first items, providing said the items on said website in a way that allows interaction with said items by a purchaser, and also taking a first action that causes real items that are not on said website to be provided to the purchaser at a later time after said providing.

11. A system as in claim 10, wherein said first action comprises causing the item to be sent to the purchaser via a delivery.

12. A system as in claim 10, wherein said first action comprises providing a coupon to the purchaser that allows the purchaser to obtain the real items.

13. A system as in claim 10, wherein said items are special edition items that are available only for a limited period of time.

14. A system as in claim 10, wherein said items are recognizable as being the same items on both the website and in the real world.

15. A system as in claim 10, wherein said items have a cartoonized look on the website that represents their look in the real world.

16. A system as in claim 10, further comprising a return engine that allows a user to return the real world item, and automatically removes a virtual version of the item from the website based on a return.

17. A system as in claim 10, further comprising a control that allows the item to be used in a same way on the website as it is used in the real world.

18. A system as in claim 17, wherein said item is a media player, and further comprising allowing the item to play media which can be perceived on the website.

19. A system as in claim 10, wherein said website shop allows purchasing second items that can be used only on the website.

20. A method, comprising:
purchasing a media player from an online store;
responsive to said purchasing, receiving a virtual version of the media player on a website, which virtual version allows a user to play media on the website that can be perceived on the website; and
subsequent to said purchasing, receiving a real version of the media player based on said purchasing, where said real version of the media player allows playing media outside the website.

21. A method as in claim 20, further comprising playing the same media on said virtual version, and on said real version.

22. A method as in claim 20, further comprising returning the real version, and automatically removing the virtual version from the website responsive to said returning.

23. A method, comprising:
carrying out a first set of actions on a website to obtain a right to purchase an item on the website shop;
carrying out a second set of actions on a website shop to purchase both a real and a virtual item on a website shop, said real item and virtual item being associated together;
responsive to said purchase, receiving said virtual item on said website to be used on said website; and
responsive to said purchase, and subsequent to receiving said virtual item, receiving said real item.

24. A method, comprising:
carrying out a first set of actions in a virtual environment to purchase an item in the virtual environment;
responsive to said purchasing the item, receiving a virtual version of the item that can be used only in the virtual environment; and
receiving a real version of the item outside of the virtual environment, subsequent to receiving said virtual version of the item and responsive to said purchasing said item,
and wherein said real version of the item and said virtual version of the item have looks that make them recognizable as being the same item.

25. A method as in claim 24, wherein said first set of actions includes actions to pay for the item.

26. A method as in claim 24, wherein said virtual version of the item is actuated to carry out a function on the website, and said real version of the item is actuated to carry out the same function outside the website.

27. A method as in claim 4, wherein said virtual version of the item is a virtual media player that allows playing media on the website that can be perceived by a user of the website, and said real version of the item is a physical media player.

28. A method as in claim 1, further comprising automatically removing the virtual version of the item from the user's virtual environment when a user returns the real version of the item.

29. A method as in claim 28, wherein said automatically removing comprises obtaining a code indicative of the virtual version of the item having been removed, and requiring said code to return said real version of the item.

30. The method as in claim 1, wherein the item is purchased on the website with virtual currency that has no monetary value in an environment in which the real version of the item is to be used.

31. The method according to claim 30, wherein the virtual currency was obtained on the website in response to participation in a game or other activity on the website.

32. The method as in claim 1, wherein the item is purchased on the website with real-world currency that has monetary value outside of the website.
